(19) United States
(12) Patent Application Publication
(10) Pub. No.: US 2006/0265978 A1
(43) Pub. Date: Nov. 30, 2006

(54) Window kit

(76) Inventors: Robert Stein, Aurora, IL (US); Jed Richardson, Batavia, IL (US)

Correspondence Address: MCHALE & SLAVIN, P.A., 2855 PGA BLVD, PALM BEACH GARDENS, FL, 33410, US

(21) Appl. No.: 11/139,086

(22) Filed: May 27, 2005

(51) Int. Cl. E06B 3/00

(52) U.S. Cl. 52/204.5

(57) ABSTRACT

A window kit composed of molded components contains all the parts necessary to install a finished window in an window opening of a building, particularly a pre-fabricated structure. The kit includes a one piece outside frame, a one piece inside frame and a panel spanning the frames. The inside frame and the outside frame have cooperating fasteners to secure the frames together with the panel and the edges of the building opening between them. The panel has complementary apertures to the cooperating fasteners to secure the panel in the frames.

### FIELD OF THE INVENTION

This invention relates to prefabricated windows for installation in plastic utility sheds or buildings.

### BACKGROUND OF THE INVENTION

In the traditional building industry, the use of prefabricated components is conventional and increasing in diversity. New materials are also being introduced, at a rapid pace, into buildings. The use of large molded plastic components has given rise to modular buildings which can be purchased as a kit and assembled from the preformed parts. Such buildings can be used for many purposes. For example, out buildings, such as tool sheds, storage sheds, garages, animal shelters, and other enclosures may be completely assembled from molded components. The panels for the buildings may be molded in relief to have exterior simulated natural finishes, such as brick and mortar, stone, weatherboard, etc. In building panels with one ply, the interior molded finish may have a contour that is the reverse of the exterior.

Typically, these modular buildings are molded with all the necessary pieces in a particular location, including the windows and doors, according to the design of the mold. However, because the sheds may be put to so many different uses and situated in so many places, the specific layout of the prefabricated window openings may not be the optimum for the location or the use of the building.

For instance, utility sheds are well accepted for use in storage of lawn and garden equipment, as well as general all-around home storage space. Typically, items such as garden tractors, snow blowers, tillers, ATVs, motorcycles and the like consume a great deal of the garage floor space available, forcing the homeowner to park his automobile outside. A utility shed may employ a number of different panel systems, or kits, comprising blow molded or extruded panels and connector members for forming a wide variety of smaller sized storage structures. If a utility shed is mass produced, it is not practical to form intricate shapes and/or sharp corners required for integrated connectors necessary for a window. In addition, blow molded plastic components are hollow and cannot be formed with the integral strengthening ribs and gussets possible with injection molding. In this example, the owner may wish to place a window where it does not interfere with the storage items, or on a wall where natural light would be most beneficial.

What is needed in the art is a modular window that may be incorporated in the building after the optimum location or locations is/are determined.

### SUMMARY OF THE PRESENT INVENTION

Disclosed is a window kit for use in a pre-fabricated plastic utility shed. The kit includes a one piece outside frame, a one piece inside frame and a panel spanning the frames. The inside frame and the outside frame have cooperating fasteners to secure the frames together with the panel and the edges of the building opening between them. The panel has complementary apertures to the cooperating fasteners to secure the panel in the frames. The window of the instant invention incorporates a minimum number of components to construct a rigid enclosure that increases the strength of the wall, thus simplifying assembling the enclosure. The interlocking construction of the window creates a structural reinforcement for securement to larger sidewalls without loss of strength.

Therefore, it is an objective of this invention to provide a modular window kit for covering an opening formed in a structure.

It is another objective of this invention to provide an open interior frame for trimming out an opening formed in a structure.

It is a further objective of this invention to provide an open exterior frame for trimming out an opening formed in a structure.

It is still another objective of the invention to provide a transparent panel spanning the opening of the interior and exterior frames.

It is yet another objective of this invention to provide cooperating elements on the interior frame, the exterior frame and the transparent panel to secure the components together in the structure.

Other objectives and advantages of this invention will become apparent from the following description taken in conjunction with the accompanying drawings wherein are set forth, by way of illustration and example, certain embodiments of this invention. The drawings constitute a part of the specification and include exemplary embodiments of the present invention and illustrate various objectives and features thereof.

### BRIEF DESCRIPTION OF THE DRAWINGS

FIG. 1 is an exploded view of the window kit of this invention;

FIG. 2 is a plan view of exterior surface of the outside frame of this invention;

FIG. 3 is a side view of the outside frame of this invention;

FIG. 4 is a plan view of the enclosed surface of the outside frame of this invention; and

FIG. 5 is a plan view of enclosed surface of the inside frame of this invention;

FIG. 6 is a plan view of the exterior surface of the inside frame of this invention;

FIG. 7 is a side view of the inside frame of this invention;

FIG. 8 is a plan view of the transparent panel of this invention; and

FIG. 9 is a cross section of the transparent panel of this invention.

### DETAILED DESCRIPTION OF THE INVENTION

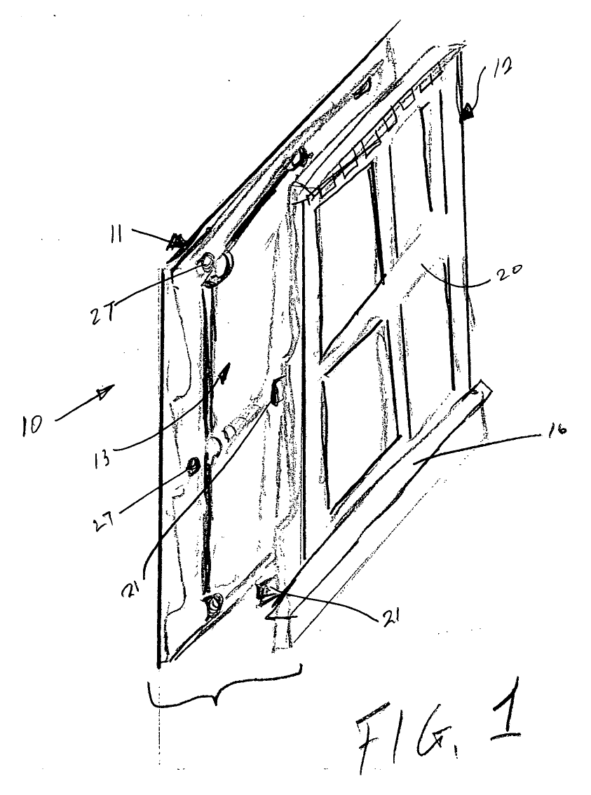

The window kit 10 shown in FIG. 1 has three major molded components, the inside frame 11, the outside frame 12 and the transparent panel 13. These components are molded from plastics, reinforced plastic, fiberglass, carbon fibers, and combinations thereof or any other material of requisite characteristics. The components are molded with complementary surfaces to closely fit together in an assembled window with the exterior wall of a building (not shown) between the inside frame and the outside frame. Optimally, the window kit 10 is supplied along with building panels that have no pre-formed openings allowing the consumer to make openings and install the windows, as desired.

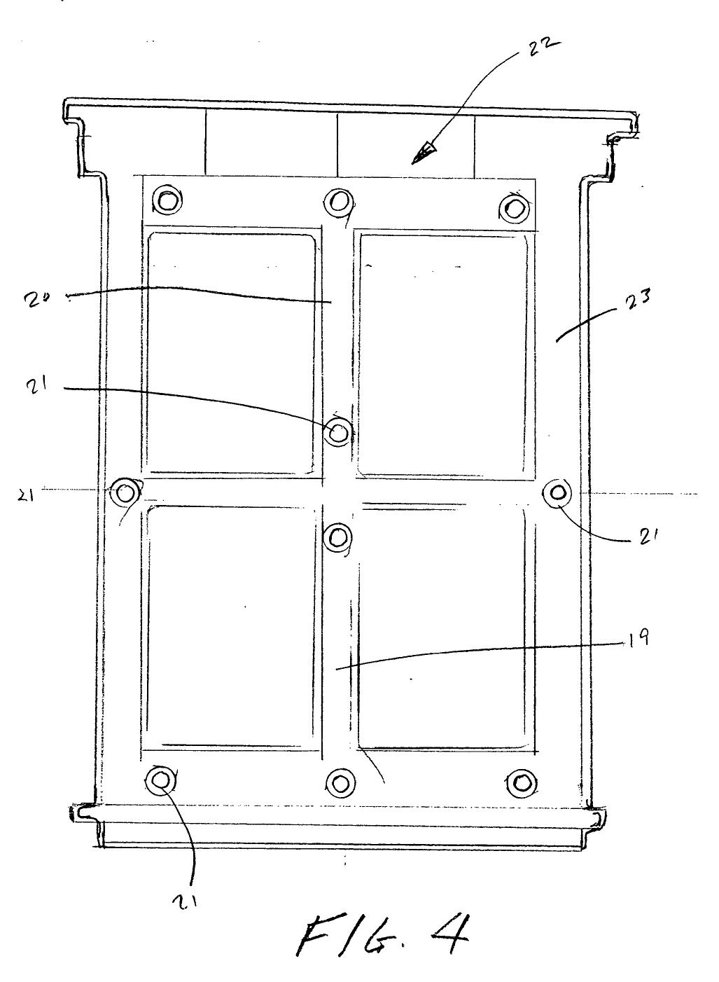

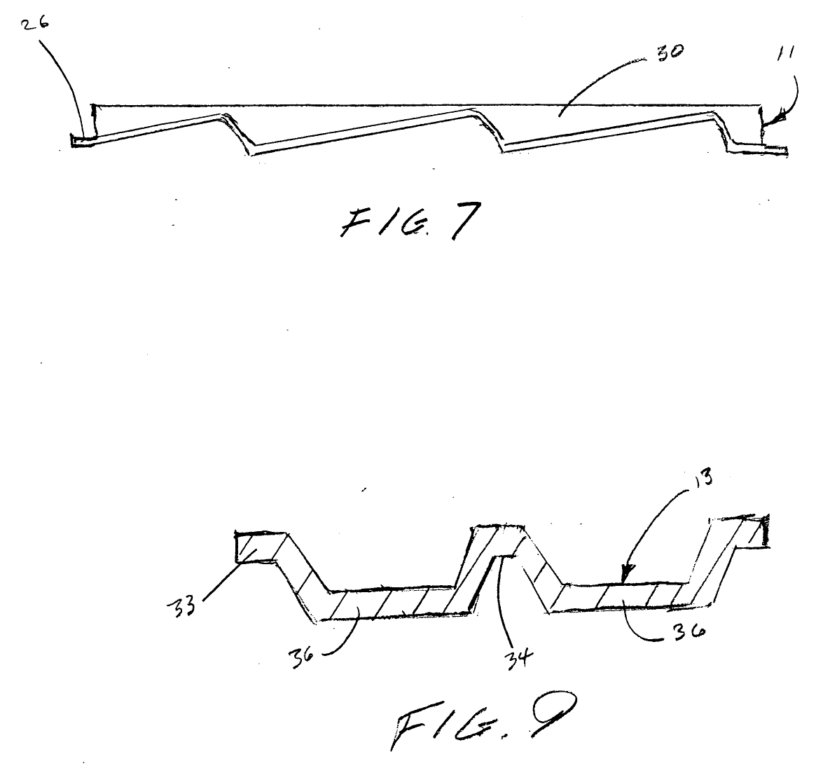

As shown in FIG. 1, FIG. 3 and FIG. 7, this embodiment is molded to cover an opening cut, or otherwise formed, in a building wall constructed of weatherboard or molded to simulate weatherboard. The side edges of the inside frame 11 and the outside frame 12 are scalloped to match the cross section of overlapped boards or simulated overlapped boards. These scalloped edges form a seal with the building wall when the window is installed in the wall. As shown, the inside framell has a series of molded enlarged female fastener pins and the outside frame 12 has a matching series of male fastener pins which hold the frame together when they are interconnected. Of course, the fasteners may be reversed. The transparent panel 13 is sized and shaped to fit within and span the margins of the frame members. The panel 13 has a series of apertures through which pass the female fasteners of the inside frame 11 for assembly. As shown, the integrally molded transparent panel 13 has a group of simulated panes which are displaced from the general plane of the panel. This construction of the transparent panel 13 adds rigidity, as well as, the decorative appearance of individual window panes. The transparent panel may also be planar, if desired.

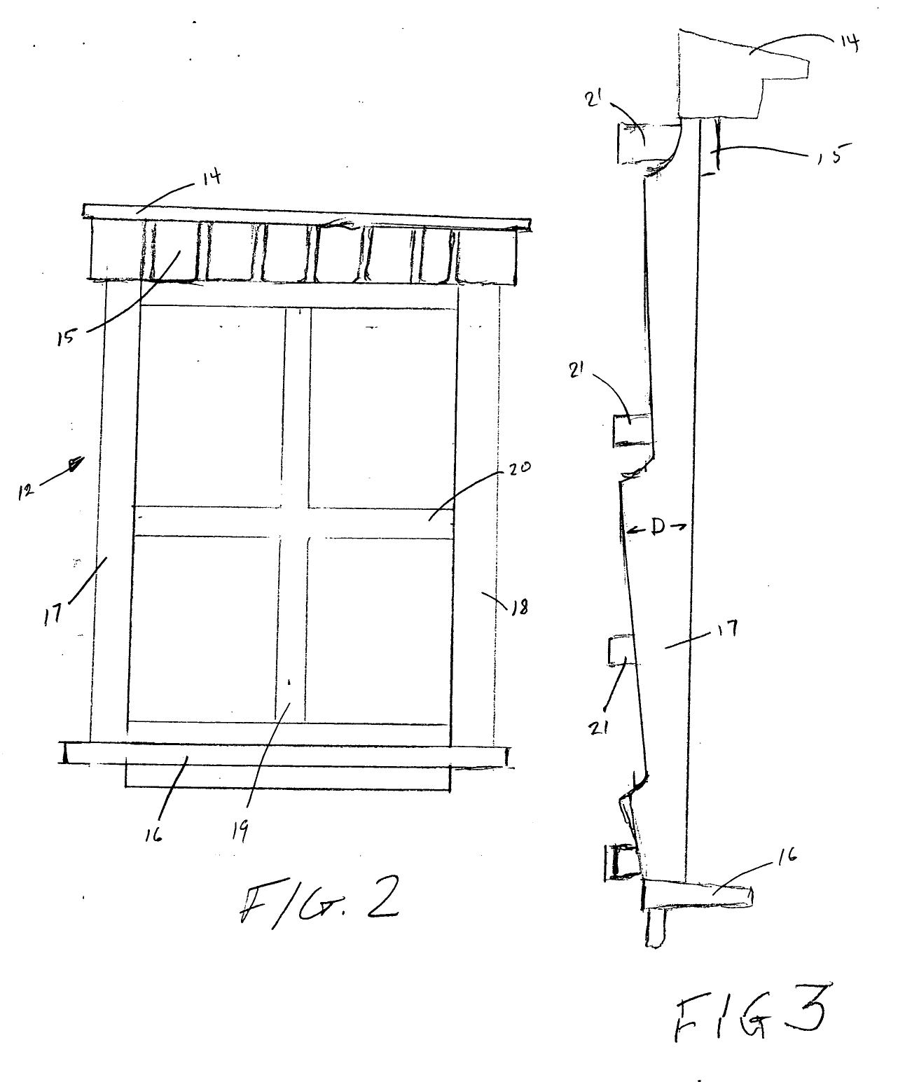

As shown in FIG. 2, the exterior surface of the outside frame 12 has a lintel 14 and a decorative fascia 15 at the top and a sill 16 along the bottom connected by vertical frame rails 17 and 18. The outside frame 12 also has a vertical mullion 19 and a horizontal mullion 20 joining the top with the bottom and the opposite sides, respectively. The mullions increase the strength and rigidity of the outside frame and contribute to the appearance when combined with the transparent panel in the final assembly.

The edges of the vertical frame rails 17 and 18 have a depth D which is non-uniform, in this embodiment, to closely fit against a weatherboard appearing surface. The depth D is scolloped in a pattern to match the building surface and provide an outside window frame that is in the vertical plane. The depth and pattern of the edges of the vertical frame rails can be molded or otherwise formed to match the exterior surface of other buildings. The male fasteners 21 extend perpendicularly from the outside frame to a depth to engage the female fasteners of the inside frame.

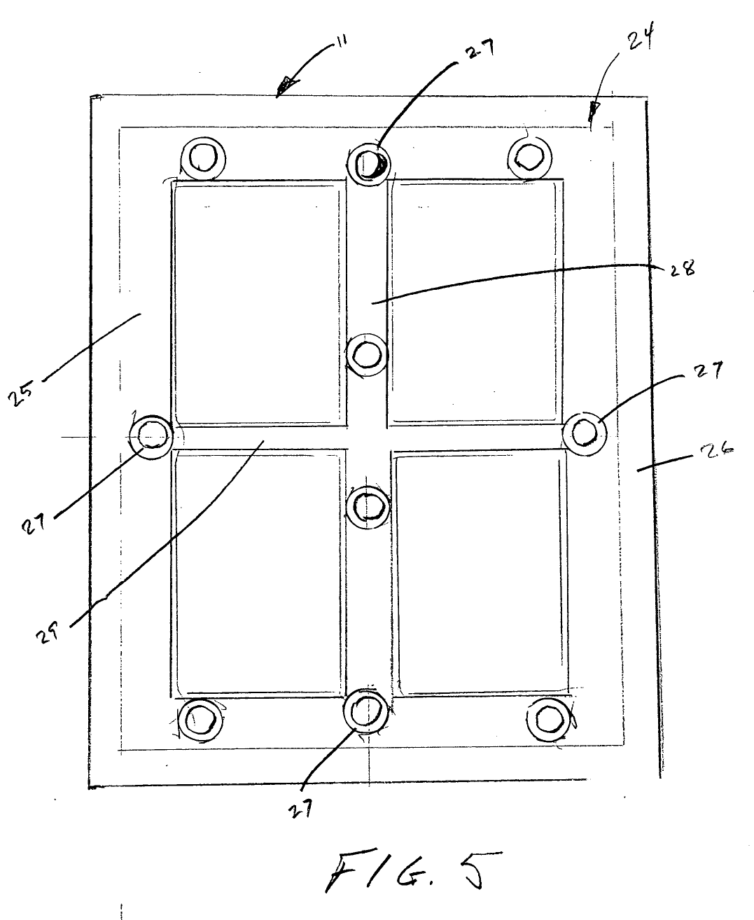

The enclosed surface 22 of the outside frame 12 is shown in FIG. 4. A channel 23 extends around the periphery of the enclosed surface. The male fasteners 21 are located within the channel 23. The mullions 19 and 20 are also formed as open channels. Within the channel of the vertical mullion 19 are more male fasteners, one on each side of the horizontal mullion 20. Of course, the location of these two fasteners could be reversed.

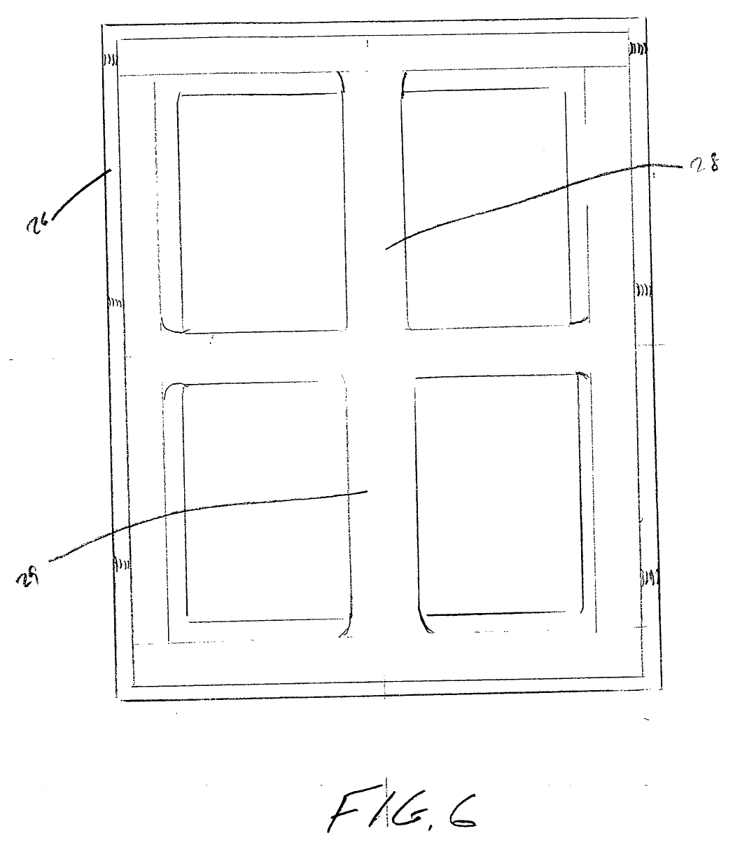

The enclosed surface 22 of the outside frame is juxtaposed with the enclosed surface 24 of the inside frame 11, shown in FIG. 5. The enclosed surface 24 also has a channel 25 about the periphery of the frame. A flange 26 extends latterly from the outer wall channel 25. This flange 26 forms a seal with the interior wall of the building. Within the channel 25 are the complementary female fasteners 27 for engaging the male fasteners 21. The fasteners 27 are of a height to extend through the thickness of the transparent panel 13. The mullion 28 of the inside frame is channel shaped with two female fasteners located, one on either side of the horizontal channel shaped horizontal mullion 29. The depth of the male fasteners and the height of the female fasteners are such that the outside mullions and the inside mullions contact the opposite sides of the transparent panel 13 in the final assembly. The male and female fasteners form a friction fit as they are telescoped together. Of course, adhesives or solvents may be added to the fasteners, if desired. In FIG. 6, the exterior surface of the inside frame is shown with the mullions 28 and 29 set inside the exterior surface of the frame. The scalloped vertical edges are also indicated.

FIG. 7 illustrates the vertical side edges 30 of the inside frame 11. The top of the frame is to the right and the bottom is to the left of the Figure. The side edge 30 is scalloped to closely contact the building inside wall in a weatherboard construction or simulated weatherboard construction. The depth of the side edges is such to provide a vertical inside frame on a weatherboard surface.

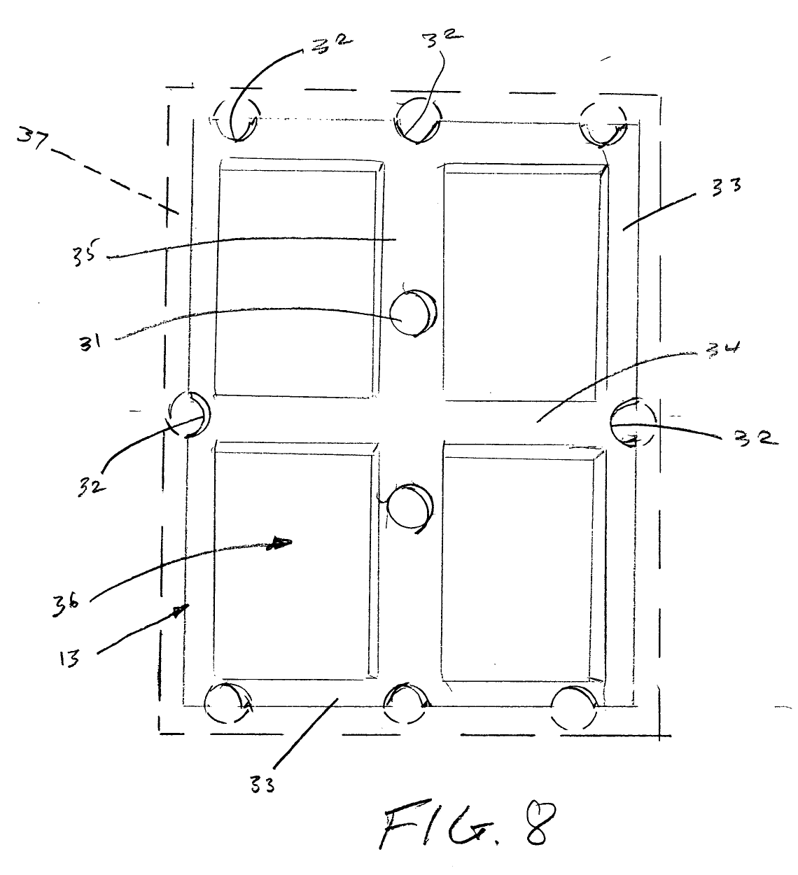

The transparent panel 13, as shown in FIGS. 8 and 9, is molded or otherwise formed as a unitary piece of a size and shape to fit within the inside and outside frames. The panel has complementary apertures 31 and demi-apertures 32 for the male and female fasteners of the inside and outside frames. Obviously, the panel can be frosted, tinted or translucent, if desired. The materials may include polymers, such as polyethylene, polycarbonate, or any other suitable moldable material. The panel has a general plane defined by the periphery 33 and the intersecting horizontal and vertical dividers 34 and 35. As shown, 4 rectangular panes 36 are formed in relief from the general plane. This construction increases the strength and rigidity of the panel. Also, the mullions fit within the dividers in the final assembly producing the appearance of individual window panes. The rectangular shape of the panes can be changed to other geometrical shapes, if desired.

A template 37, shown in dotted lines in FIG. 8, is used to locate and determine the dimensions of the opening necessary for installation of the window 10. The template 37 can be of paper or other material easily disposable. Other wise, the size of the opening may be documented merely as measurements in length and width.

A number of embodiments of the present invention have been described. Nevertheless, it will be understood that various modifications may be made without departing from the spirit and scope of the invention. Accordingly, it is to be understood that the invention is not to be limited by the specific illustrated embodiment but only by the scope of the appended claims.

What is claimed is:

1. A window kit for installation in an opening in a building comprising an outside frame for placement on the outside surface of a building about an opening, an inside frame for placement in the interior of a building about an opening, and a panel adapted to span said outside frame and said inside frame, said outside frame and said inside frame having cooperating fasteners adapted to connect said outside frame and said inside frame together with said panel therebetween, said panel including apertures for passage of said cooperating fasteners.

2. A window kit of claim 1 wherein said outside frame includes a lintel, a sill, opposite side rails connecting said lintel and said sill, said lintel, said sill and said opposite said rails are molded in one piece.

3. A window kit of claim 1 wherein said inside frame includes a top, a bottom, opposite side rails connecting said top and said bottom, said top, said bottom and said opposite said rails are molded in one piece.

4. A window kit of claim 3 wherein said outside frame includes a lintel, a sill, opposite side rails connecting said lintel and said sill, said lintel, said sill and said opposite said rails are molded in one piece.

5. A window kit of claim 2 wherein said molded one piece includes intersecting unitary mullions connecting said lintel and said sill and connecting said opposite side rails.

6. A window kit of claim 3 wherein said molded one piece includes intersecting unitary mullions connecting said top and said bottom and connecting said opposite side rails.

7. A window kit of claim 6 wherein said outside frame includes a lintel, a sill, opposite side rails connecting said lintel and said sill, said lintel, said sill and said opposite said rails are molded in one piece said molded one piece includes intersecting unitary mullions connecting said lintel and said sill and connecting said opposite side rails.

8. A window kit of claim 1 wherein said panel is composed of a molded planar surface with a plurality of panes, said panes molded in relief from said planar surface.

9. A window kit of claim 5 wherein said panel is composed of a molded planar surface with a plurality of panes, said panes molded in relief from said planar surface, said panes separated by dividers in said planar surface, said mullions adapted to be disposed in said dividers.

10. A window kit of claim 6 wherein said panel is composed of a molded planar surface with a plurality of panes, said panes molded in relief from said planar surface, said panes separated by dividers in said planar surface, said mullions adapted to be disposed in said dividers.

11. A window kit for installation in an opening in a building comprising an outside frame for placement on the outside surface of a building about an opening, an inside frame for placement in the interior of a building about an opening, and a panel adapted to span said outside frame and said inside frame, said outside frame and said inside frame having integral cooperating fasteners adapted to connect said outside frame and said inside frame together with said panel therebetween, said panel including apertures for passage of said cooperating fasteners, said outside frame includes a lintel, a sill, opposite side rails connecting said lintel and said sill, and intersecting mullions, said lintel, said sill, said opposite said rails and said mullions are molded in one piece, said inside frame includes a top, a bottom, opposite side rails connecting said top and said bottom, and intersecting mullions, said top, said bottom, said opposite said rails, and said mullions are molded in one piece, said panel is composed of a molded planar surface with a plurality of panes, said panes molded in relief from said planar surface, said panes separated by dividers in said planar surface, said mullions adapted to be disposed in said dividers.
